(19) United States
(12) Patent Application Publication
(10) Pub. No.: US 2005/0256813 A1
(43) Pub. Date: Nov. 17, 2005

(54) Method and system for data understanding using sociomapping

(76) Inventors: Radvan Bahbouh, Prague (CZ); Kamil Bahbouh, Prague (CZ)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/084,008

(22) Filed: Mar. 21, 2005

Related U.S. Application Data
(60) Provisional application No. 60/556,385, filed on Mar. 26, 2004.

(51) Int. Cl. G06F 15/18; G05B 15/00

(52) U.S. Cl. 706/1

(57) ABSTRACT

Methods and apparatuses consistent with the present invention facilitate visualizing information represented by data. Method steps consistent with the present invention include processing the data with a fuzzy logic coding unit, generating a fuzzy logic model related to the processed data, and generating a Sociomap visual representation of information represented by the data. An apparatus consistent with the present invention includes a data collection unit, a fuzzy logic coding unit, a fuzzy logic model analysis unit, and a Sociomap generating unit that renders a visual representation of information represented by the collected data, the information resulting from the fuzzy logic coding model and fuzzy logic model analysis unit.

### CROSS REFERENCE TO RELATED APPLICATIONS

The present invention claims the benefit of U.S. Provisional Patent Application No. 60/556,385 filed Mar. 26, 2004, and is herein incorporated in its entirety by reference.

### DESCRIPTION OF THE INVENTION

1. Field of the Invention

The present invention relates generally to data understanding systems and methods and more particularly to modeling and visualizing data.

2. Background of the Invention

Information technologies facilitate the collection of large amounts of data which can subsequently be statistically processed. In spite of this, data extraction within the scope of the decision-making processes is usually inadequate due to a human's reduced capacity for the perception of numerical information. Notwithstanding the data collected, many people orient themselves visually by relying on cursory impressions of the data. Moreover, data overload leads to the selection of only a certain part of the data and key information is subsequently lost among the vast collection of data.

One of the limitations of conventional data analysis techniques is that a large part of the population, which is not sufficiently mathematically literate, would have to rely on a narrow group of specialists who would both analyze and interpret the data. An alternative to conventional techniques should provide a user-friendly presentation of data that supports a more natural, commonly used deliberation processes for our decision making.

To a certain extent, there is a parallel to the beginning era of computers when their use was initially reserved for a small group of people who were able to speak in computer languages and codes. Later, the development of a more convenient control interface made computers available to the general public. An available interface should be developed in a similar manner for the use of mathematical statistics without requiring above-average mathematical knowledge. This would make it possible to achieve effective and transparent data management.

There is, therefore, a need for Sociomapping, which departs from conventional data analysis and visualization methods and enables the aggregate processing and visualization of data. Examples of systems suitable for visualization using Sociomapping include, but are not limited to, social systems. Visualization improves our orientation in data and hence our decision-making process.

### SUMMARY OF THE INVENTION

Methods and apparatuses consistent with the present invention facilitate visualizing information represented by data. Method steps consistent with the present invention include processing the data with a fuzzy logic coding unit, generating a fuzzy logic model related to the processed data, and generating a Sociomap visual representation of information represented by the data. An apparatus consistent with the present invention includes a data collection unit, a fuzzy logic coding unit, a fuzzy logic model analysis unit, and a Sociomap generating unit that renders a visual representation of information represented by the collected data, the information resulting from the fuzzy logic coding model and fuzzy logic model analysis unit.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate embodiments consistent with the present invention and together with the description, serve to explain the principles of the invention.

### BRIEF DESCRIPTION OF THE DRAWINGS

The accompanying drawings provide a further understanding of the invention. They illustrate embodiments consistent with the present invention and, together with the description, explain the principles of the invention.

FIG. 1 is a data matrix representing information coded numerically;

FIG. 2 is a visual coding of the numerical information depicted in FIG. 1;

FIGS. 3a and 3b are matrix representations comparing ability to recall information related to the position of objects in space;

FIG. 4 is an example of a fuzzy distribution;

FIG. 5 compares a hard criterion-based assessment of set membership with a fuzzy method of membership assessment consistent with the present invention;

FIG. 6 is a schematic of fuzzy set mapping using multi-criterion decision making consistent with the present invention;

FIG. 7 is a an exemplary fuzzy set for one element consistent with the present invention;

FIG. 8 is a set of fuzzy sets for individual elements consistent with the present invention;

FIG. 9 is a Sociomap consistent with the present invention;

FIG. 10 is a Sociomap consistent with the present invention;

FIGS. 11a, b, and care Sociomaps consistent with the present invention;

FIG. 12 is a flow diagram of a Sociomapping process consistent with the present invention;

FIG. 13 is a schematic diagram of a Sociomapping system consistent with the present invention;

FIG. 14 is a Sociomap depicting a system over several time periods consistent with the present invention;

FIG. 15 is an example of Sociomapping applied to psychological profile data consistent with the present invention; and

FIGS. 16-20 are Sociomaps at different time intervals consistent with the present invention.

### DESCRIPTION OF THE EMBODIMENTS

Reference will now be made in detail to the embodiments consistent with the present invention, examples of which are illustrated in the accompanying drawings. Wherever possible, the same reference numbers will be used throughout the drawings to refer to the same or like parts.

Today we are overwhelmed by information. We gather more and more information in an effort to base our decision-making on sufficiently solid ground. The crucial problem of information management no longer consists of finding methods for obtaining new information, but instead focuses on finding our way through the existing information. We often encounter situations where extensive research is presented, but the recipients are not able to take in all the important data, choose the essential message, and decide how to react. It is difficult to transform a huge amount of data, diagrams, tests, and tables into a simplified “picture of results.” In most cases, therefore, we retain only selected information that complies with our original expectations. A complex pattern of mutual relationships typically remains beyond the limits of our perception.

Sociomapping enables combined processing and visualization of data representing social systems. Visualization improves orientation in data and hence the ability to make decisions using the data. Sociomapping has many uses in applications that process large volumes of data.

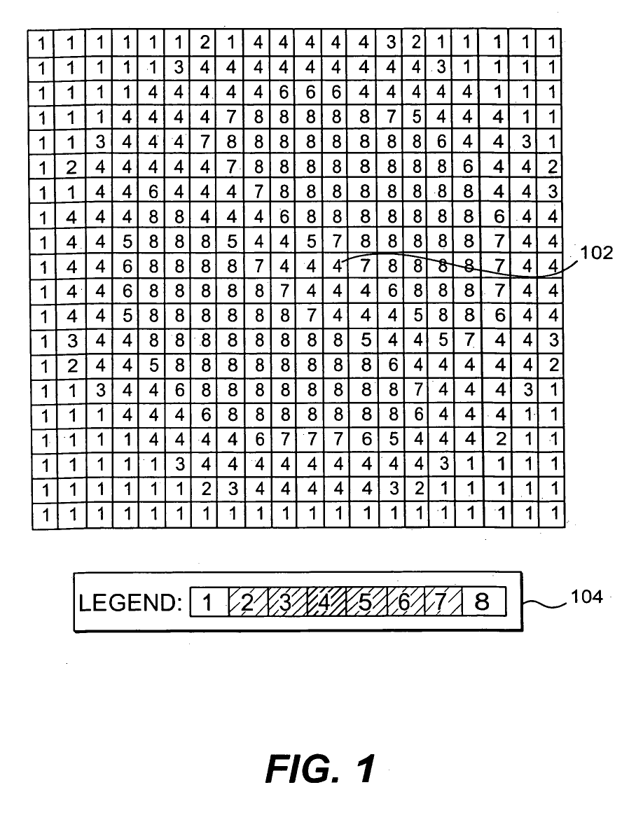

One method for extending information processing capacity, is to transition from numerical coding to imaging. Numerical coding can quickly overburden our memory and in many cases, hinders insight into hidden data patterns. FIG. 1 is an example of a data matrix representing numerical information. Each data element (e.g., element 102, row 10, column 12, having the value ‘4’) represents one value in a matrix of 400 data elements. In this example, each data element value corresponds to a grey level amplitude ranging from one to eight (see Legend 104). Using the technique for information representation in the data matrix of FIG. 1, the information intended to be conveyed is not readily apparent.

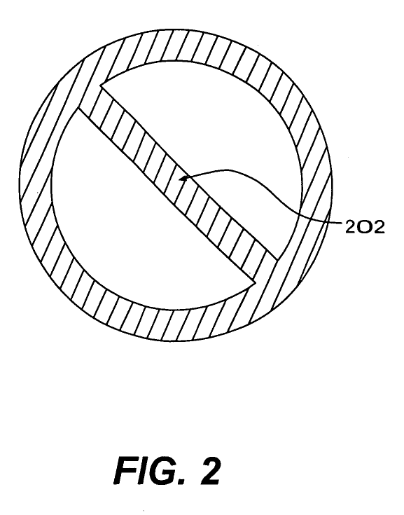

FIG. 2 is a graphical representation of the numerical information depicted in FIG. 1. Instead of presenting the data elements as numbers, they can be presented as grey level magnitudes. For example, the numerical value 102 in FIG. 1 is depicted as grey level value 202 in the image of FIG. 2 (which has been filtered to remove all other grey level values). It is apparent that the graphical encoding of the information in FIG. 2, provides better and faster insight into the information intended to be conveyed by the matrix of data elements in FIG. 1. Accordingly, FIG. 2 illustrates that an image of the data elements in FIG. 1 conveys information in manner that may be more apparent than a presentation of the data elements themselves. In another example of this concept, if one tried to numerically encode information representing conference participants' seating arrangement by coordinates in a meeting hall, the corresponding data element matrix would contain a large amount of data. These data could change over time. It would not be at all trivial to acquire information on the participants' proximity and distance from these data. In comparison, a photograph or video recording of the hall (i.e., visual coding) provides immediate information on how distant the participants are from each other and a dynamic picture of significant movement.

Unlike sensory perception of a surrounding area, numerical coding is a skill of advanced phylogenetic and ontogenetic development. Humans are able to solve a number of mathematically demanding tasks, such as following a moving point, or predicting changes of the position of objects, without substituting numbers in computationally difficult differential equations. From birth, humans develop the ability to orient themselves in space and engage in spatially dependent decision making. Numerical thinking and spatially visual thinking have different capacities. While human numerical processing is easily over saturated with data and loses sight of the overall relationship of information embedded in the data, visual thinking can provide a more comprehensive idea of the encoded information.

When dealing with a limited amount of data, optimal decision-making does not present much of a challenge. At present, however, we frequently face an overwhelming amount of data. It is usually impossible to look over all of the data in a single glance. As a result, the data are typically reduced with statistical parameters that preserve only the most important information. In some situations, however, there can be such a vast quantity of data that reducing it using statistical parameters will not make the data appreciably more manageable.

Consider the layout of a scientist's office. Given the distances between the objects within the office and their positions, would one be able to create an image of his office? If, instead, the scientist took a photo of the office, one glance would be sufficient. Given this visual representation of the layout, it would be possible to estimate the distances between the objects with sufficient accuracy without overburdening our memory. Sociomapping is based on the idea that beyond the data concerning a complex system, there is a simple and easy-to-understand relational image. This hidden image can be estimated on the basis of reflections corresponding to individual variables.

Numbers and figures are not the most easily intelligible information representation of data, which is further complicated by the mind's limited capacity for their intake and storage. Information may be presented in other forms, however, which are easier for humans to retain and use. While one can do without significant numerical processing capacity in life, it is difficult to get along without the capacity for spatial orientation. From the first moments of our life, the brain has evaluated information about our position and movement in space. It is, therefore, no surprise that the brain's informational capacity is much larger in this respect and that decision-making based on the positions of objects is natural and easy for us despite the huge amount of data which goes into it.

Consider the above-mentioned office and imagine that the objects in it change locations over time. The information defining the distances between objects may change over time. Thus, the picture of the office will change over time depending on the data. Certain objects will have a steady position in the picture, while others will move. If the appearance of an object is equally probable in any area of the office, the object disappears from the picture because its representation would mislead the decision-making process.

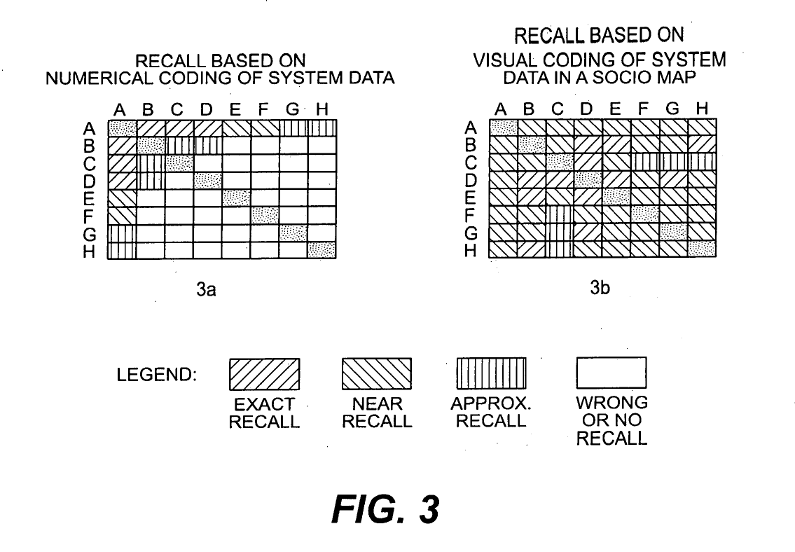

FIGS. 3a and 3b represent the difference in the cognitive workload and memory requirements between two techniques for conveying information. Consider a system comprised of several objects located in space. Coding the mutual positions of the objects numerically (i.e., coded in numbers) provides a very precise representation of each distance, but it is very difficult to recall all the data and very difficult to visualize the system represented by the data. Alternatively this system can be represented by a map. The correlation matrix of FIG. 3a represents the first situation, where recall for several subjects was tested. The subjects remembered precise data for a limited time of only a part of the matrix (e.g. first line or column). The amount of data presented caused an overload and the subjects failed to pay attention and recall the rest of the matrix. FIG. 3b is a correlation matrix illustrating recall for subjects given a Sociomap of the system data. The method of Sociomapping leads to lower accuracy for recall of individual distances between objects in the system, but the subjects were able to correlate a wider range of the objects in the system compared to the subjects given only numerical data. Note the wider distribution of recall in the matrix of FIG. 3b. Sociomaps, therefore, provide information on the whole configuration—gestalt. Further information enables further focusing within the given shape. Sociomapping uses visuo-spacial processing to exploit the idea that beyond the data there is an image that humans cannot see, that spatial orientation is possible within the elements of a system between which there are relationships expressed by data, and that numerical data can be coded into a visual representation of the information conveyed by the data elements.

Sociomapping can be used to analyze socioeconomic and other systems to reveal hidden structures within complex systems and monitor their dynamics. Embodiments of Sociomapping consistent with the present invention use fuzzy theory, pattern recognition, and mathematical topology to combine information from various sources about a system. Dynamic Sociomapping records changes of a non-linear dynamic system and may either depict the changes in the video comprising several Sociomaps, or display the difference between the subsequent stages of the system in differential Sociomaps.

Sociomapping monitors important characteristics of inter-elemental relationships, which include, for example, capturing the degree of stability and the composition of these relationships (including their inner conflicts and disagreements), mapping communication currents (the degree of their functionality in each direction), and uncovering the weaknesses in the social system structure. Additionally, a Sociomap reflects a system's dynamic development and tension build-up, and allows for the short-term prediction of future behavior (e.g., conflicts, miscommunication, etc.) and trends.

Sociomapping produces a Sociomap. A Sociomap is a graphic expression of significant information obtained through an analysis of a system. In a Sociomap, each element can be, for example, represented by a point. The height of each point can reflect the data value of one chosen output parameter (e.g., level of communication, social position, importance, etc.) while the distance between two elements can generally represent the level of the relationship (e.g., closeness, mutual ties, cooperation, etc.) derived from more than one variable. A set of isolines and other graphic parameters can express the quality of the relationship. Information obtained from a sequence of Sociomaps can be compared to that provided by the synoptic maps used in meteorology. Requiring only minimal orientation, Sociomaps are a swift and efficient tool for data analysis even when analyzing the most complex systems.

Another strength of Sociomapping is that numerous methods of data collection may be used as sources of information, including, for example, psychological tests, expert evaluations, and behavioral variables. Objective and subjective, quantitative and qualitative, verbal and numerical data may be included. Consistent with the present invention, the collected is transformed into fuzzy models, which may then be aggregated according to similarities in structure patterns. Discrepancies and selected critical patterns may then be subjected to further analysis as potential indications of significant changes (as compared to stable patterns of the system).

Sociomapping is useful in the analysis of complex systems with multidimensional and ambiguous relationships between the subjects and/or objects. Sociomapping also considers interactions between (social) elements. This analysis is aimed at revealing the (social) system's inner structure and the dynamics of its change. The analyzed interactions can be complex and multi-leveled. Relationships between two elements may represent a set of sub-relations, which may differ from each other. For example, if the relation at hand is the communication between two army units, sub-relations may include written correspondence, direct communication, and telephone communication. The size and complexity of an analyzed social system may vary. Sociomapping can be applied to the analysis of systems as small as three-member groups and as large an entire army. Individuals, groups, departments, or army units may represent elements of the system.

A feature of Sociomapping is the method's broad use in the field of social intervention. Sociomapping is suited for the continuous analysis of a system. The process provides the user with a picture of the given system and its changes in time, helping the user make decisions and interventions. Additionally, Sociomapping provides feedback on the results of the user's intervention and decisions.

Sociomapping may presume that there is no single relationship between the system's elements (distance), but rather a great number of relationships (distances) that decide how close the given elements are to each other and how they are accessible to each other. Consistent with the present invention, this proximity may then be modeled using fuzzy sets, which create a fuzzy image of the examined system.

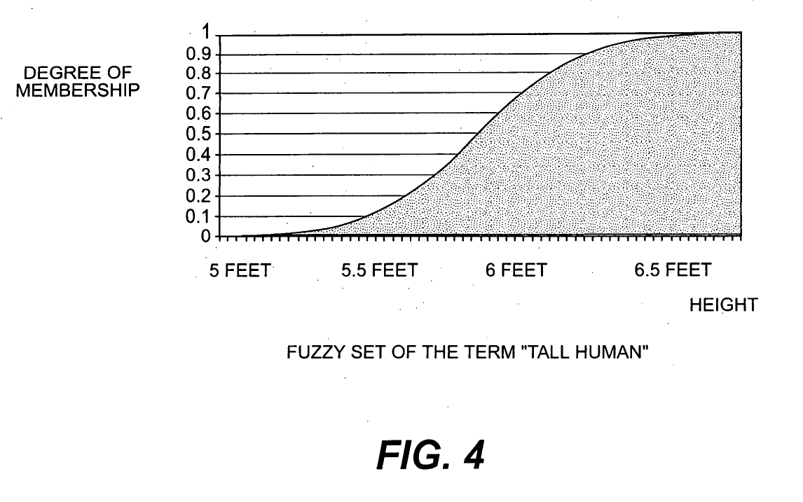

Fuzzy models address limitations of complex traditional mathematical models that do not provide the expected results. Whereas traditional mathematics strives for precise and semantically “sharp” definitions of the terms used, natural language is softer, less definite and thus more flexible in specific situations. In the classic theory of sets, an element is either definitely in or not in a set. Fuzzy set theory presume a wide range of intermediate stages where some elements belong to the given fuzzy set more than others. While the definition of adult people corresponds to the classic set of all people who are of age under the law in force, the limits of the term old people are less sharp; some people definitely come under this category and others less so, often depending on the context in which the given term is used. Old people as well as nice people, tired people, tall people, therefore, are fuzzy concepts. The same holds true for words such as blue, fast, much, evening, late, clearly, easily, etc. (See, e.g., FIG. 4 depicting a fuzzy set for a “tall” human.)

In fuzzy sets, elements come under the set with a certain “degree of membership,” which is a real number between 0 (does not belong at all) and 1 (positively belongs). The fuzzy set notation may, for instance, look like this:
A={0.7/B; 0.9/C; 0.3/D; 0.2/E}

This fuzzy set consists of element B with a degree of membership of 0.7, element C with a degree of membership of 0.9, element D with a degree of membership of 0.3 and element E with a degree of membership of 0.2. The degree of membership may thus express the proximity of individual elements to element A. The specific content of this proximity is defined by various procedures leading to the determination of the degree of membership. In addition to probabilities this may be a question of correlation, similarity, expert estimate, and a wide range of other indicators. The degree of membership can express the real, direct connection between elements in a system (direct Sociomapping) or a mediated, indirect relationship (indirect Socimapping) obtained, for example, through similarities of data profiles.

For direct Sociomapping, when modeling communication flows, for instance, the degree of membership may correspond to the probability that news travels from point A to point B in a certain time. For example, an analysis of the movement of people within a group indicates the average distance between two persons that can be converted into a scale from 0 (maximum possible average distance) to 1 (minimum possible average distance). Another example is people giving their opinion on a continuous scale of how much they like working with others.

For indirect Sociomapping, in opinion polls the interconnection of groups of supporters of various parties is observable by finding the percentage of people who prefer one party (one politician), but also think highly of another party (another politician). In a competitive products Sociomap one may observe how many people who own product A subsequently acquired product B. The degree of membership, however, is not restricted to the probability of transition between different states. Proximity may be obtained through other procedures as well. The degree of similarity can also be derived from similarities in data profiles.

Fuzzy sets corresponding to particular elements of a system can be “layered” one on top of another creating a fuzzy model. Its simplified notation is a matrix of degrees of membership, where in row i and column j we will find a degree of membership of element j to the set of element i. This matrix is generally asymmetric, as this general concept of proximity does not have to be reciprocated. If we like a certain person from a group of people best, this does not necessarily imply that the person likes us too. A fuzzy model can be thought of as a blurry image of a system that corresponds to a certain type of described relations. There can be many such fuzzy models. Overlapping blurry images may reveal a repeating pattern that was not clear from individual “data planes” (individual matrices). This overlapping is called aggregation. Not only can difference variables from different fuzzy models be aggregated, but data from short time intervals can also be aggregated into longer time intervals (by using, for example, the average value of the degree of membership).

Each of the fuzzy models may describe a particular type of relationship between the elements. At the same time, it is influenced by other factors burdening the data with undesirable interference. Aggregation removes interference and identifies patterns in the data. Repeating patterns of several fuzzy models can be removed to reduce redundancy. This permits focusing on the significant differences between an aggregated model and an original fuzzy model. The hidden system structure is visible at various data levels. The data may also be burdened by incompleteness (e.g., missing data) and uncertainty. With aggregation, matrices containing data representative of relationships may have various weights of importance obtained through mathematical procedures or expert estimations. An aggregated model enables searching for specific relational patterns. For example, in a group of three people, where a central person stands between two others who are far from each other, it may indicate either jealousy (between the two others regarding the central figure) or an appropriate mediator (the central person), depending on the context. Finding pre-defined patterns leads to a better understanding of the system. One such procedure may be, for example, dividing the system into coherent subsystems that are transformed into a Sociomap arranged by isolines. Coherence (i.e., inclusion in the same subsystems) of the elements usually corresponds to criterion concerning the level of their relationship. Frequently this is the weaker of the two or more mutual relationships (degrees of membership). A simple notation of a coherence analysis may be:
(((A,C)_{0.9}B)_{0.7}(D,E)_{0.8})_{0.2}
which means that the most coherent pair in the given system is pair A and C with a degree of coherence of 0.9. Element B affiliates with this pair on the level of coherence of 0.7. This is, therefore, the most coherent threesome in the system. Another coherent pair is pair D and E, bound to each other with a degree of coherence of 0.8. The lowest level of coherence in the system is 0.2. This means that, in this example, the lowest degree of membership in this system is 0.2.

A Sociomap is a graphic representation of an aggregated model. The system elements are depicted on Sociomaps by marks with height corresponding to one selected quantitative variable (e.g. importance, preference, general knowledge, diffusiveness and the like). Mutual proximity in the terrain corresponds to the proximity of the elements or probability of transition between them. The Sociomaps can be used in a different mode to represent the relationships of subjects to objects (elements) in the model (indirect Sociomapping). For example, a Sociomap may represent public opinion. Each “mountain” on the Sociomap can represent one political party, and its height is proportional to the electoral preferences. In fact, these mountains correspond to fuzzy sets. Just below the peak of the mountain are firm supporters. The farther away from the peak of the mountain, the more other political options are possible. Currently undecided voters may stand between several mountains as they may sympathize with several parties. In terms of their relative positions, some political parties are more acceptable (closer) than other parties.

Each individual has a location on the Sociomap of his/her most probable occurrence on the basis of distances from objects under study. This point corresponds to the centroid of its occurrence, and, in some cases, this point may move actively within the area and change positions, or it may even be found in several places at the same time with a certain probability. One example of such a situation is a Sociomap of a field of competitors that represents groups of consumers of various products or brands. The consumer may use several different products at the same time, thus increasing corresponding surfaces in several areas of the Sociomap simultaneously. The subject should be rendered in multiple places in the Sociomap (with respective weight) if scaled preferences or non-exclusive decisions are depicted.

A Sociomap is not limited to a three-dimensional model with only the three coordinates having a meaning. In addition to height, which has been discussed, interconnections between the elements are also important. The correlations can be encoded in the relief, i.e. field distance. The greater the distance (or the lower the degree of membership), the more difficult the “transport” between the points becomes. Although longitude and latitude have no specific meaning, individual element characteristics may change as latitude and longitude change, thus the most different elements are usually found on the opposite sides of the Sociomap.

The computation of a Sociomap should respect several criteria. In an embodiment consistent with the present invention, a Sociomap meets basic rules (translation rules) that require, among other things, that the ordinal rank of distances of one element to other elements in the system is the same as ordinal rank of the corresponding distances in the original data matrix. Such a Sociomap preserves the ordinal arrangement (structure) of data. The Sociomap can depict asymmetry at the same time. If one element is the closest to another element, this does not have to hold true reciprocally. Apart from terrain breaks, isolines can help express the system splitting into subgroups. With their help, it is possible to show the forced approximation of two elements without a change of distance.

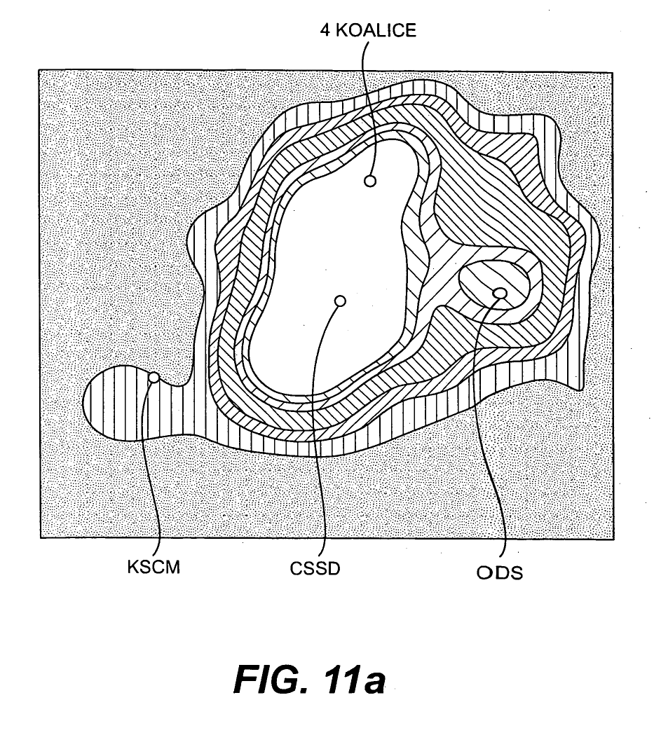

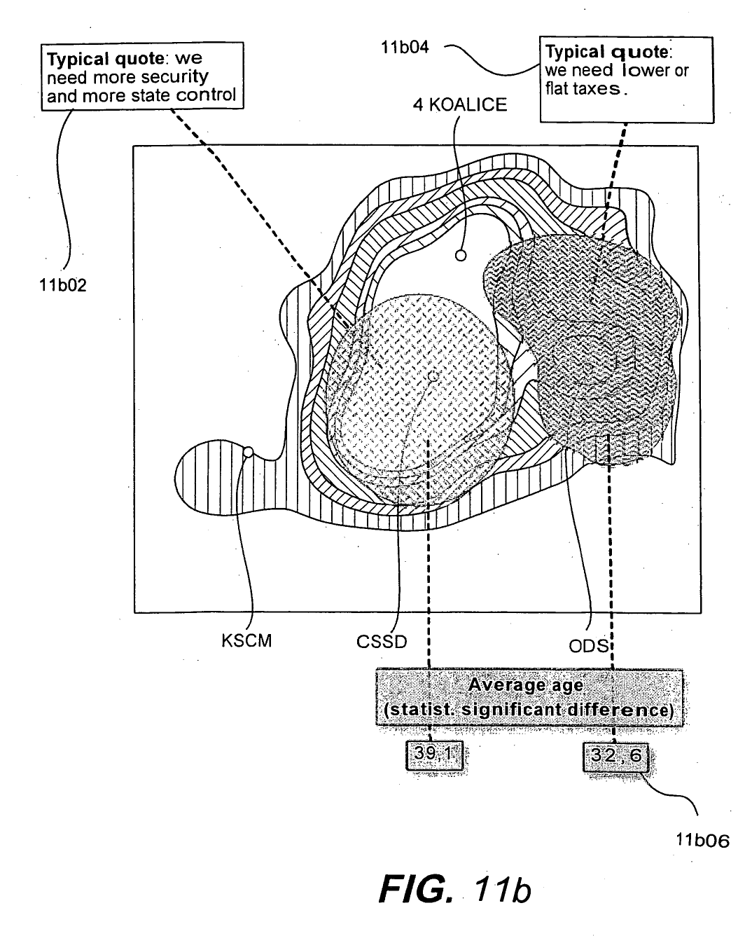

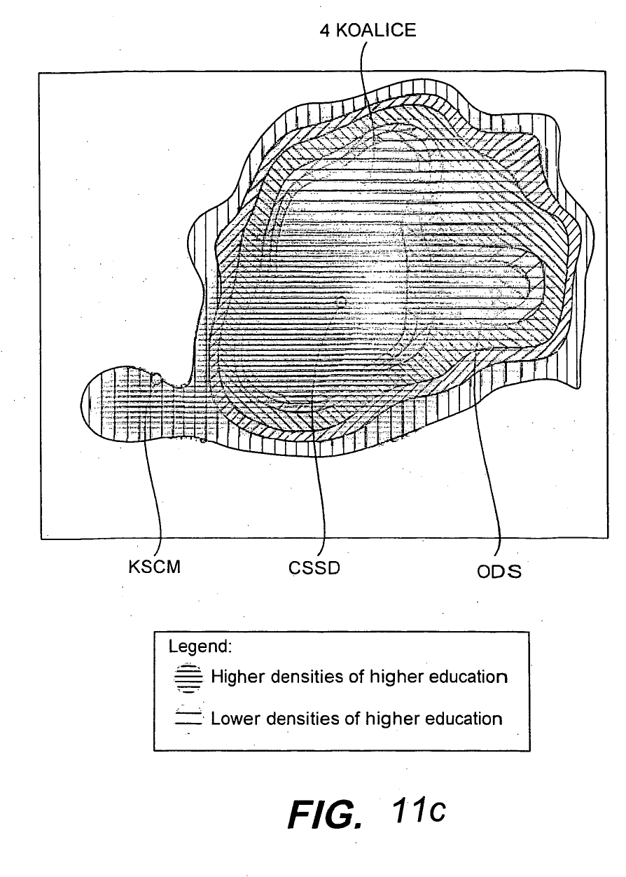

A Sociomap's complexity may be gradational. What seems to be one mountain from a distance may be divided into further sections when viewed closer. In this way, zooming in on some elements of the Sociomap may reveal their internal structure. If the Sociomap shows the relationships between teams within an organization, it is also possible to simultaneously create a separate Sociomap of each team's internal structure. From a mathematical point of view, a Sociomap is a connectionist model of a non-linear dynamic system. It is connectionist because important coded data are connections between individual elements. Socio-economic systems are non-linear dynamic systems because the data are constantly changing and influence each other in a complex manner. Data updating may lead to modification of Sociomaps. Monitoring a system continuously generates a series of Sociomaps allowing oncoming situations to be predicted on the basis of the recorded changes and displayed trends for the whole system. Sociomaps may also be used as a basic medium for the visualization of statistical test results, for example, in obtaining information about the relationship between age, education, etc., and position on a given Sociomap (FIG. 11c). Based on the descriptive statistics and statistical tests of subgroups corresponding to sets of “mountains” and their intersections and differences, it may be apparent that older or younger people gather in certain areas of the Sociomap more than in other areas (e.g., area containing subjects with a higher than average age). In a similar manner, areas can be revealed on the Sociomap where women, students, doctors, etc. concentrate with higher probability than their proportion in the general population. This can be visualized though indicators (density scales) that highlight these occurrences on the Sociomaps. This representation can be significant when representing a target group for detailed analysis. For instance, the representation can show where those who intend to buy a particular product in the near future are clustered. Thus, we can find that in certain places of the Sociomap there are deserts with almost no one, and in other places large communities are “camping” between the mountains.

In Sociomaps of competitive products it is possible to direct a marketing campaign at a target group based on values of variables that differ reasonably (or are statistically significant) between the current and the target position. Gradient is a term for significant differences between two positions or between two areas (see, e.g., FIG. 11b). These can be, for example, price curves describing the perception of prices, age, the reading of particular magazines or different value preferences. Thus, valuable data are available for marketing, in contrast to the common and often meaningless practice of averaging target group data. On the basis of specific features it facilitates the finding of access keys, i.e. appropriate methods of addressing the group. By using quantitative and qualitative data it is also possible to find and display typical members of difference subpopulations. Marketing campaigns conducted in this manner allow for feedback-optimization according to the obtained data. Evidence-based marketing can be achieved by following up with a properly conceived promotional and advertising campaign with a subsequent check of position changes within the Sociomap.

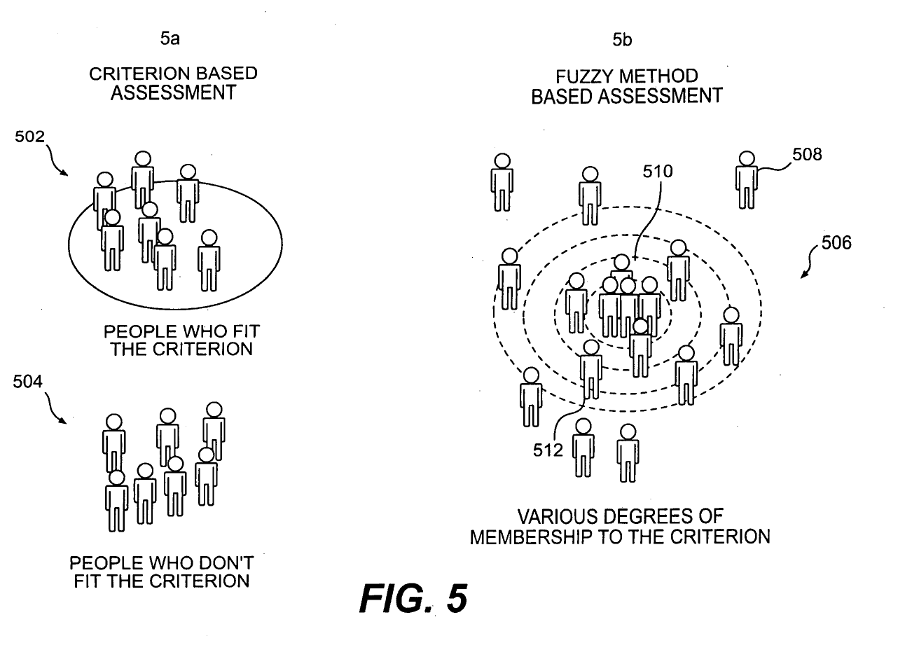

The following example illustrates the use of fuzzy set theory in Sociomapping. FIG. 5 compares a hard criterion-based assessment of set membership (FIG. 5a) with a fuzzy method of membership assessment consistent with the present invention (FIG. 5b). In FIG. 5a, a population is divided into two disjoint sets, people who fit the criterion (502) and people that do not fit the criterion (504). In contrast, instead of creating a sharp division by assigning individuals into two disjoint sets, a fuzzy approach consistent with the present invention assigns various degrees of membership to a class defined by a criterion (506). Some individuals will have a weak degree of membership to the set (e.g., 508), some will have a strong degree of membership to the set (e.g., 510), and some will lie somewhere in between (e.g., 512). A concrete fuzzy set may resemble, for example, a hill where elements are depicted with heights that correspond to their degrees of membership. The height, in this example, is determined by the position between concrete isolines.

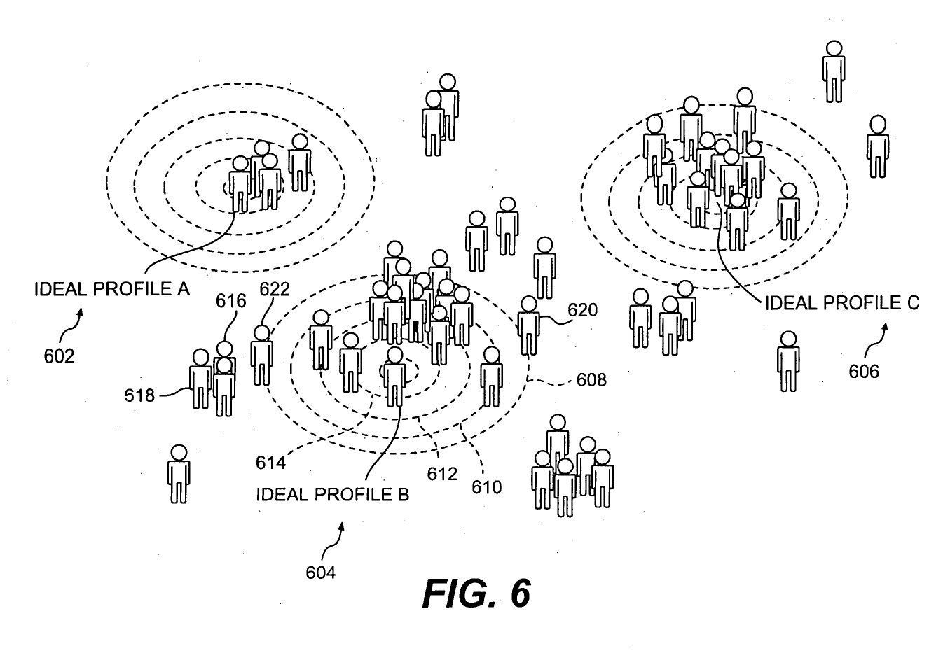

FIG. 6 is a schematic of fuzzy set mapping using multi-criterion decision making consistent with the present invention. In the example illustrated in FIG. 6, the population is distributed on the Sociomap according to psychological test results. In this example, there are three different profiles, Profile A (602), Profile B (604), and Profile C (606). The distance between the profiles can be measured, for instance, by the aggregate of percentile differences. In this manner, a matrix of distances can be obtained, where distances relate to the difference in the profile between subjects. The more two subjects differ in their profile, the greater the distance between them. The assessed individuals are also related to an ideal profile obtained, for example, by benchmarking. The entire situation can be represented as a target or mountain, in the center of which is the ideal profile (e.g. Profile B (604)). Individual isolines (e.g., 608, 610, 612, and 614) correspond to the distances from the ideal. If some people are close to one another (e.g., 616 and 618) it is clear that their profiles are similar and it is possible to choose without problems the person who is closer to the ideal profile. If the evaluated people are at opposite sides of the mountain on the same isoline (i.e. at the same distance) (e.g., 620 and 622) it is clear that we must search for qualitative differences of their profiles. In this case we may choose which type to prefer. This assessment target is a fast procedure for processing a lot of data for a large number of people. It is a procedure that facilitates decision-making.

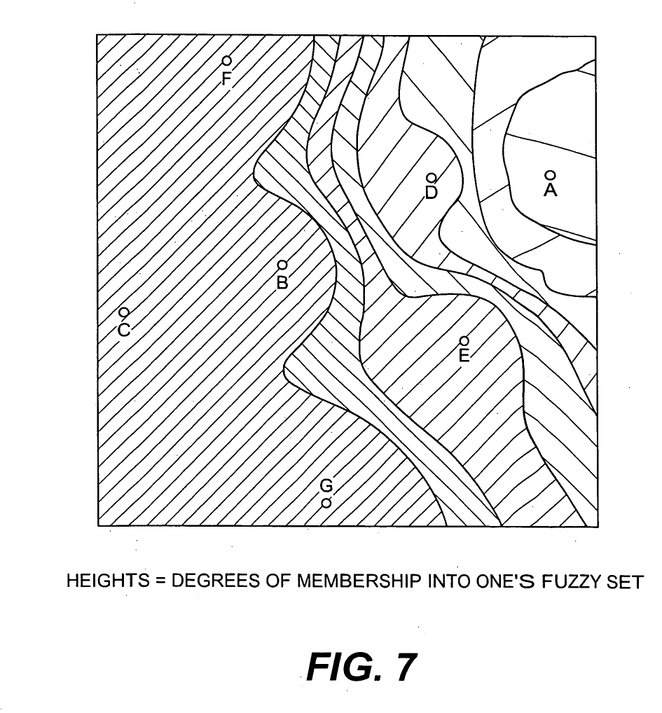

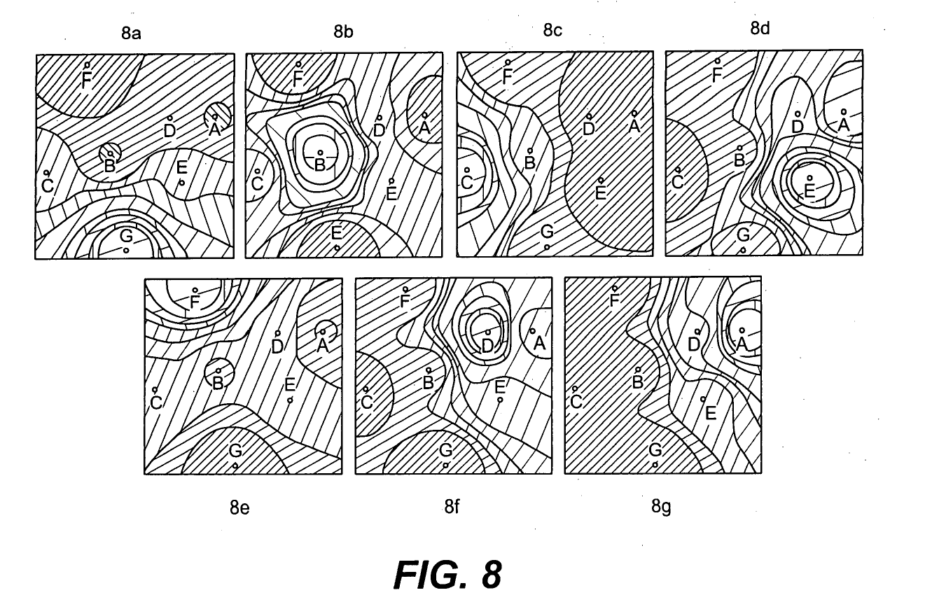

FIG. 7 is an example of a fuzzy set of one person (Person A) consistent with the present invention. The degree of membership for a fuzzy set is indicated by the shaded bands that correspond to height extending the topographical representation to three-dimensions. Although FIG. 7 and subsequent figures in this specification use shading and varying fill patterns to indicate a degree of membership on the Sociomaps depicted, other representations of this information are also consistent with the present invention, including, but not limited to, color coding, gray scale shading, multi-dimensional rendering, three-dimensional spatial coding, or other similar methods of indicating the same information. For example, consistent with the present invention, heights in a Sociomap can be coded using different colors thereby providing a mode of visual representation that is a natural and simple means of conveying information in comparison with other more abstract techniques.

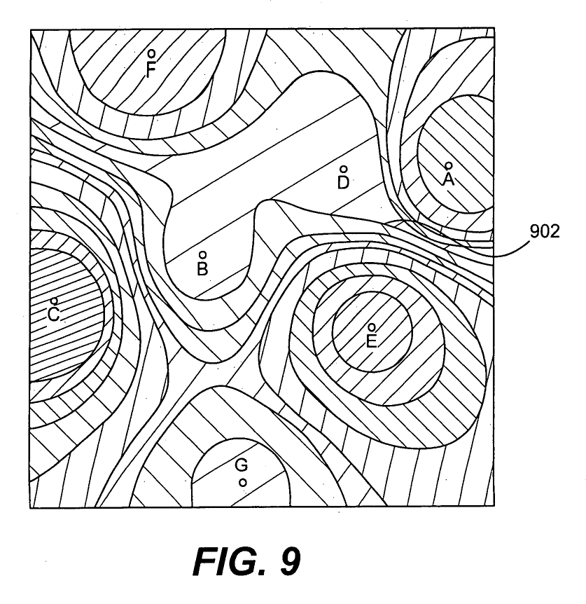

FIG. 8 depicts several of these fuzzy sets (FIGS. 8a-g). Each figure is a representation of fuzzy set membership for a different individual. FIG. 8a depicts fuzzy set membership for Person G. FIG. 8b depicts fuzzy membership for Person B. FIG. 8c depicts fuzzy membership for Person C. FIG. 8d depicts fuzzy membership for Person E. FIG. 8e depicts fuzzy membership for Person F. FIG. 8f depicts fuzzy membership for Person D. FIG. 8g depicts fuzzy membership for Person A. Sociomaps for all of the individuals can be merged into a single Sociomap (FIG. 9). This merged Sociomap representation depicts mutual relationships (degrees of membership) through distances. Heights can be used to code a concrete output variable. Individual fuzzy sets can be built into a fuzzy model of an entire system.

FIG. 9 is a Sociomap consistent with the present invention. The system of isolines (the lines depicting the boundaries between different cross-hatched regions, e.g. 902) in FIG. 9 is derived from sections at individual levels of degree of membership, which enables visualization of the inner division of the system into individual subsets. The distances between individual persons correspond to the relationships in the data in the fuzzy sets. The longer the distance (or the lower the degree of membership), the more difficult the transition between the two areas becomes. Heights are assigned, for example, to represent the value of a monitored output variable, such as productivity or managerial potential. This produces a height differentiated map in the form of a height-differentiated landscape. This is just one example Sociomapping. There are as many fuzzy models as there are different data outputs. Aggregating the individual fuzzy models to one another through Sociomapping reveal more general and, at the same time, hidden relationship patterns.

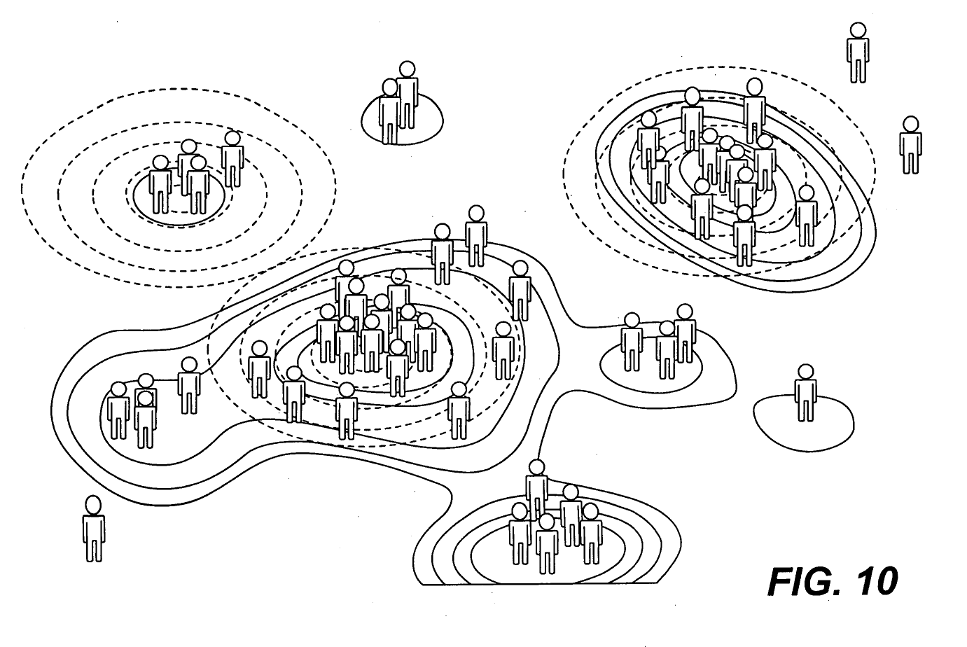

FIG. 10 is a Sociomap consistent with the present invention. A Sociomap need not represent individuals only; it can represent whole subpopulations as depicted in FIG. 10. Each of the mountains represents a fuzzy set of a specific element or object (e.g. a political party or a product), to which the subpopulations are related. This is not a real relationship between parties, it is a relationship mediated by people. This is an indirect Sociomap. For each individual person, the Sociomap can show an area of the most probable occurrence on the basis of the preference to the mapped political parties. Each person can be fixed in some position, move actively within the area and change positions, or appear in several places at the same time with certain probabilities. FIG. 11a is a Sociomap of Czech political parties, the citizen who favors ODS, 4 koalice and CSSD in the same valence can be found in between the three hills—those people are giving matter to the area in between the hills. If there are no people with ambivalent preferences, there would be no matter in between the hills. A representative sample of a Czech population of around several hundred people is depicted In this Sociomap.

Sociomaps consistent with the present invention can also be used as an interface for visualizing and controlling statistical test results. Sociomaps reveal useful information. Sociomaps, for example, may reveal that descriptive statistics and statistical tests of graphically-selected subgroups (see, e.g., 11b06 in FIG. 11b) correspond to the sets of individual “mountains” depicted in Sociomaps. Also, by looking at the distribution of the variable states in the Sociomap, contingences may become apparent such as information that the average age in the all areas of Sociomap are identical, but older and younger people gather in certain areas of the Sociomap. Women, men, managers, educated people, or other selected populations can be represented in the Sociomap in a similar manner using, for example, density scales as a varying color map (see, e.g., FIG. 11c). These variable states represent indicators that will reveal in the given model where the defined subgroups should be located. This representation is valuable when representing a target group that will be focused on in detail. In contrast to the “population Sociomaps” (this mode of drawing maps), the maps of individuals (previously described mode) contain mountains, where each mountain corresponds to one person and between the mountains there is a field of mutual relations.

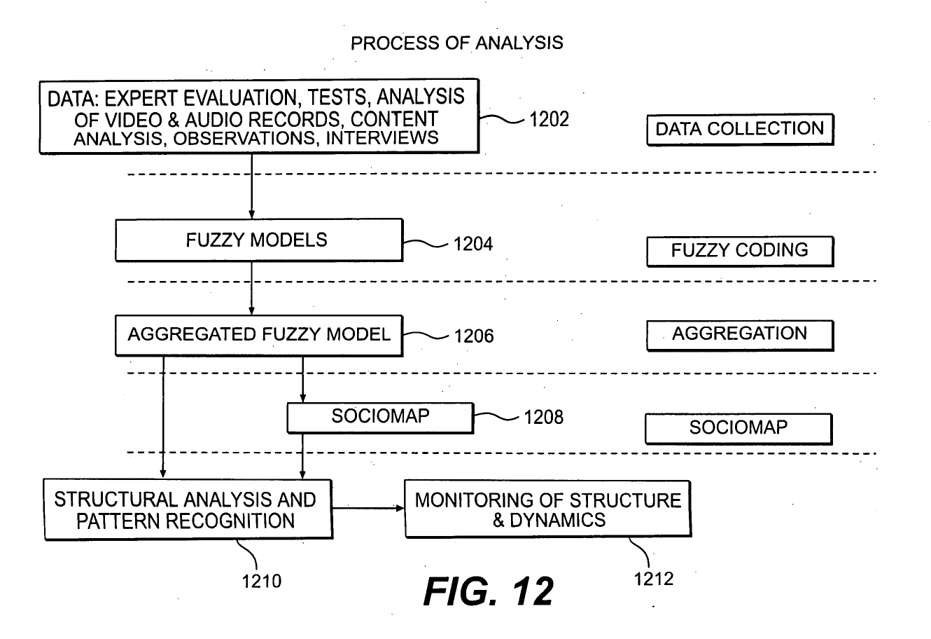

FIG. 12 is a flow diagram of a Sociomapping process consistent with the present invention for visualizing information represented by data. Relevant data is collected to serve as the underlying basis for the Sociomap, e.g, data is collected for individual subjects of objects (step 1202). The information collection and input process is sufficiently flexible to accommodate a wide variety of input, for example, document analysis, examinations of audio and video recordings, the analysis of work results, testing (including psycho-physiological testing), interviews, surveys, and direct observation. Thus, this process can use all forms of information available.

Using fuzzy coding, data are transformed into fuzzy models representing fuzzy sets of individual variables expressing the rate of mutual interconnection (similarity) between the individual elements (step 1204). The notation of fuzzy sets (degrees of membership) of individual elements gives a fuzzy model. Each element in a fuzzy model has a fuzzy set comprising other system elements with a degree of integrity representing a relationship level and its valence. Qualitative data, such as verbalized comments of respondents, that cannot be quantified are preserved in the qualitative form, and are presented in the Sociomap in the form of labels and notes (FIG. 11b, elements 11b02 and 11b04) available on user's demand.

A set of fuzzy models (levels) are aggregated to create an aggregated fuzzy model (step 1206). During aggregation, the fuzzy model undergoes further analysis, for example, different data levels are compared and related configuration patterns are revealed. At the end, the final data matrix consists of stable patterns that were found in a majority of the levels of data. Discrepancies among the data levels are recorded and analyzed. The most and least consistent subgroups, notably disproportionate relationships, and similarities in the remaining elements of the system are pointed out. In addition other expertly defined structures and patterns can be searched for (step 1210).

Individual fuzzy models are compared to each other and aggregated to create a Sociomap that reveals general data patterns not readily apparent by direct observation of the data collected in step 1202 (step 1208). Creating a Sociomap is like overlapping transparent fuzzy pictures to create an image of a structure of poor definition which is present in most of the photographs. A Sociomap provides simple insight into the structure of the groups, organizations, and other social systems. Because a Sociomap can be created on a recurrent basis, it can go through long-lasting development and watch the dynamics of a whole group or organization.

For applications that do not require a visual representation of the aggregated fuzzy models generated in step 1206, structural analysis and pattern recognition can be applied to the aggregated fuzzy model directly (step 1210). In some applications it will also be appropriate to apply the structural analysis and pattern recognition techniques to the Sociomap generated at step 1208.

The system displayed by the Sociomap can be monitored continuously to provide insight into system changes over time (step 1212). This dynamic analysis provides feedback for decision making and for evaluating intervention options.

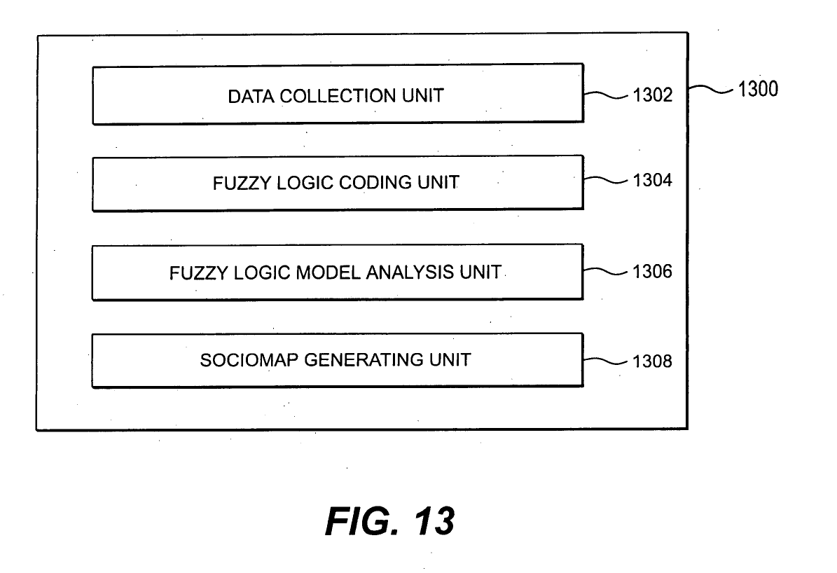

FIG. 13 is a schematic diagram of a Sociomapping system 1300 consistent with the present invention for visualizing information represented by data. The system comprises data collection unit 1302. Data collection unit 1302 collects data in any form available. Fuzzy logic coding unit 1304 transforms the collected data into at least one model representing fuzzy set membership according to designated criteria for membership. An example of such a model created by fuzzy logic coding unit 1304 includes a matrix of data elements where the value for an element in the matrix indicates a degree of membership of an element to a fuzzy set.

Fuzzy logic model analysis unit 1306 analyzes the output of fuzzy logic coding unit 1304 to ascertain the relationships among the data represented by the fuzzy model(s) generated to prepare for generating a Sociomap. If fuzzy coding unit 1304 generates more then one fuzzy set, a data aggregation unit (not shown) generates an aggregate model representative of the fuzzy models generated by the fuzzy coding unit. The data aggregation unit can use, for example, appropriate statistical tests such as, for example, those that reveal repeating patterns in data, weighted average comparisons, and correlations, to facilitate aggregation.

Sociomap generating unit 1308 creates a Sociomap visualization of the information represented by the collected data. In some applications, Sociomapping system 1300 will include a statistical interface unit (not shown) that processes data prior to rendering the Sociomap to improve the visualization of data, and/or results of statistical tests and other dependencies and patterns found in the data (see, e.g., 11b06 in FIG. 11b). A three-dimensional projection of the map which allows a virtual tour of the system is also consistent with the present invention.

Each of the elements in Sociomapping system 1300 can be implemented in hardware, software, or in a combination of hardware or software. Moreover, these elements can be located in a single device or distributed over a number of devices directly connected or connected by networks.

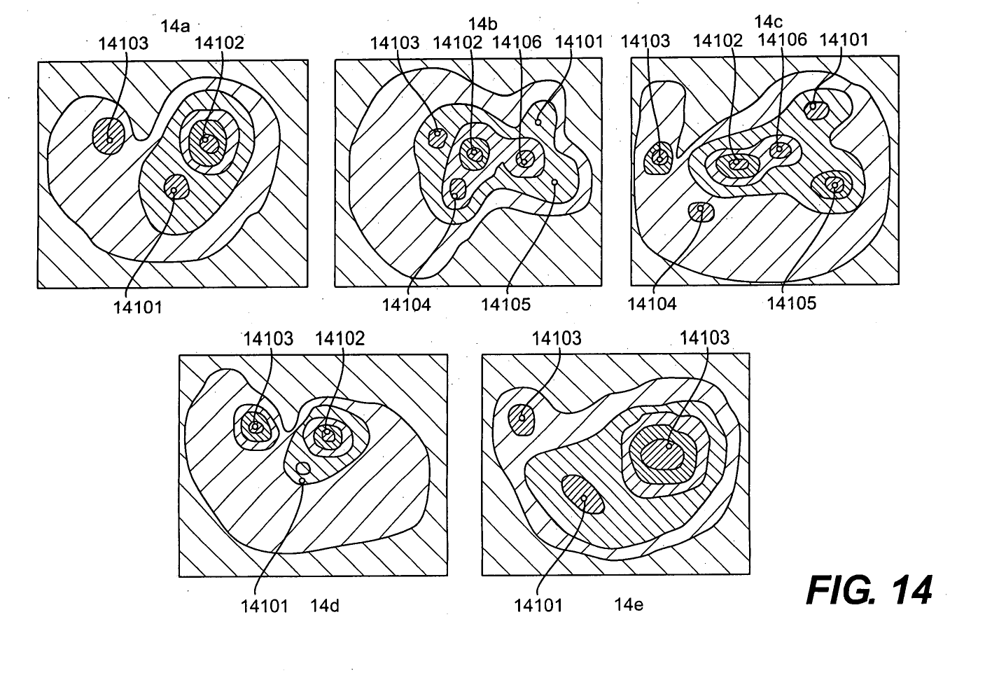

The Sociomaps shown in FIG. 14 are Sociomaps consistent with the present invention depicting two teams, where one team was isolated in the simulation of a space flight, and the second team joined the first one. Distances stand for affinity of the members of the teams, based on the data from behavioral characteristics and from psychological, sociological tests and on the similarity of physiological data. Height stands for social status. FIG. 14a depicts the team of three members, who were living in an isolated space flight simulation environment. Persons 14101 and 14102 were closer friends. The most respected person was 102 (highest hill). The sequence of Sociomaps 14b and 14c shows the relationship when another team entered the space ship. Sociomaps 14d and 14e show the state after the visitors left the ship—the isolation of member 14103 (14d), and return to the starting state (14e), similar to the structure at the beginning (14a).

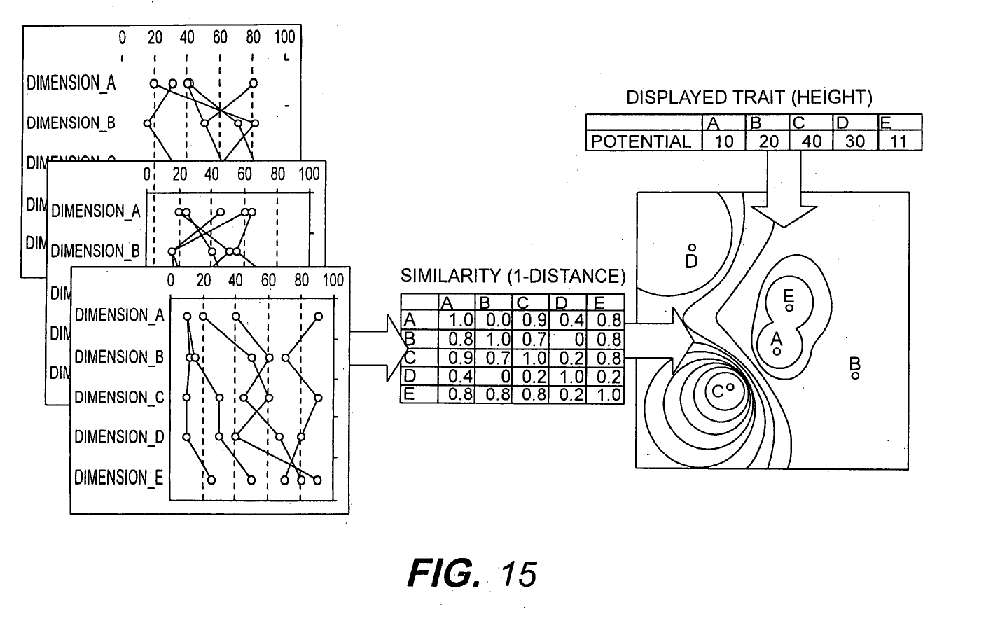

FIG. 15 is an example of indirect Sociomapping consistent with the present invention applied to psychological profile data representing a management team over several years while it was receiving coaching to improve performance. In the Sociomap of FIG. 15, distances stand for similarities (degrees of membership) of the psychological profiles and heights for managerial potential, estimated from one of the tests used. Differences among the candidates in the Sociomap can be tested for significant differences.

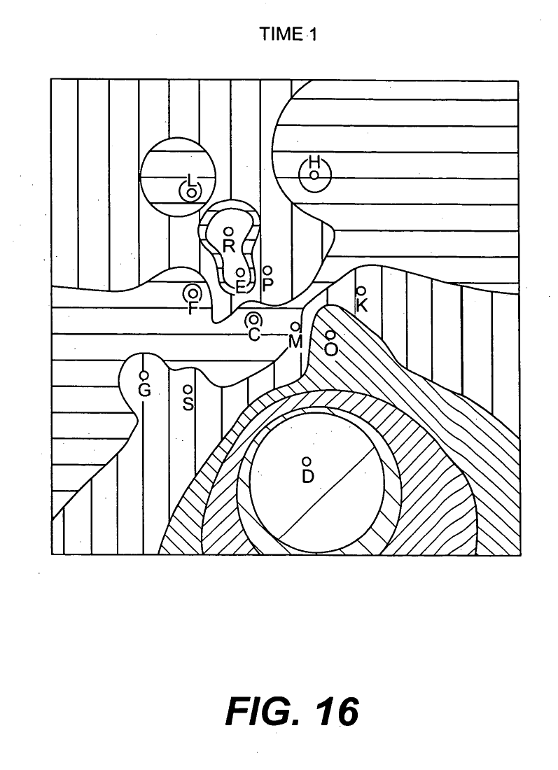

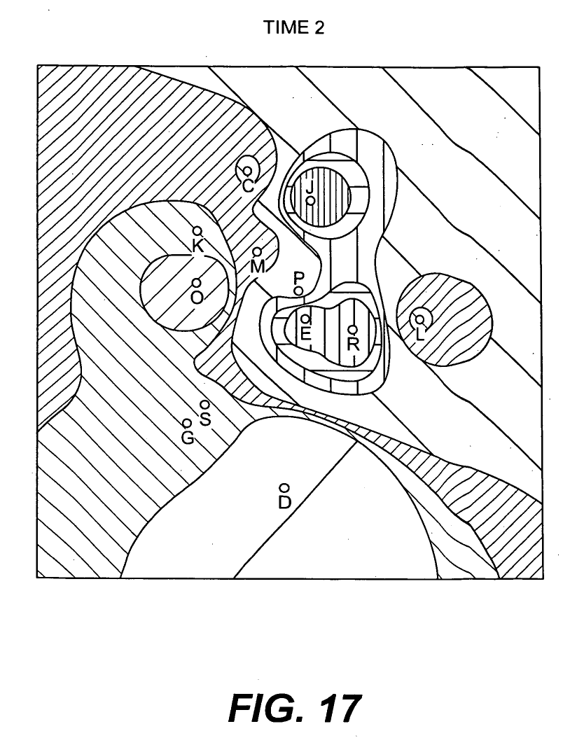

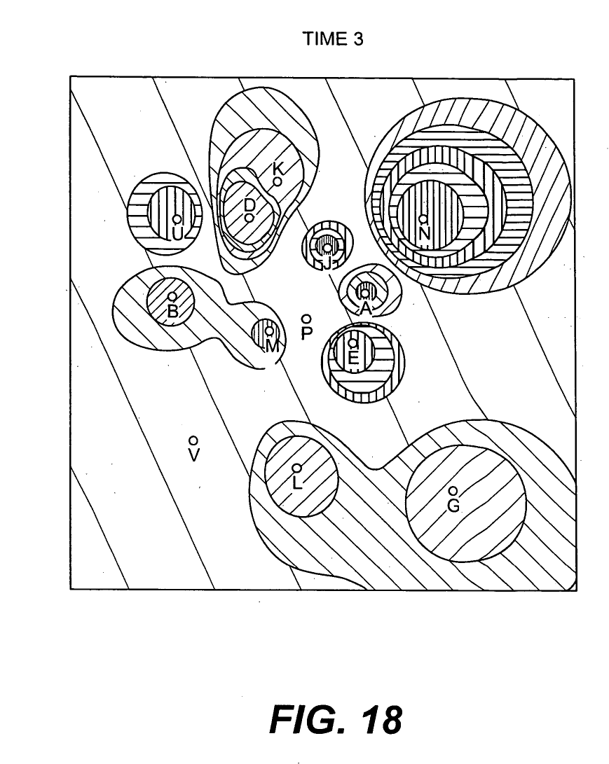

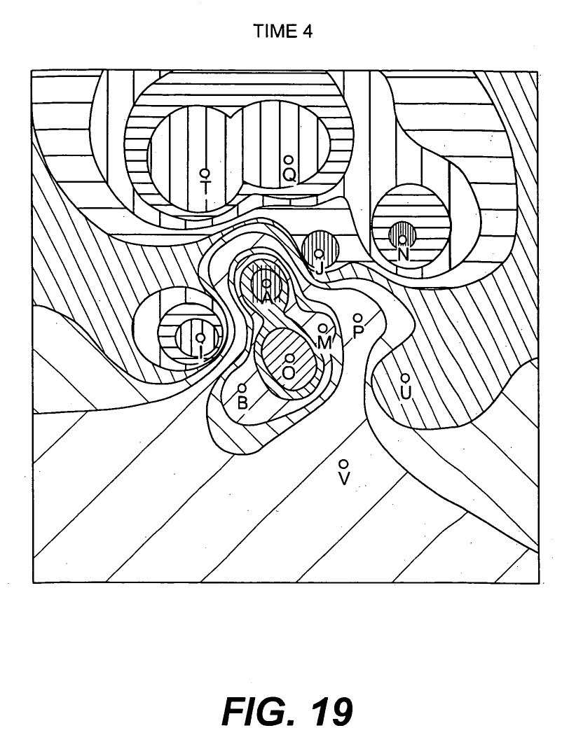

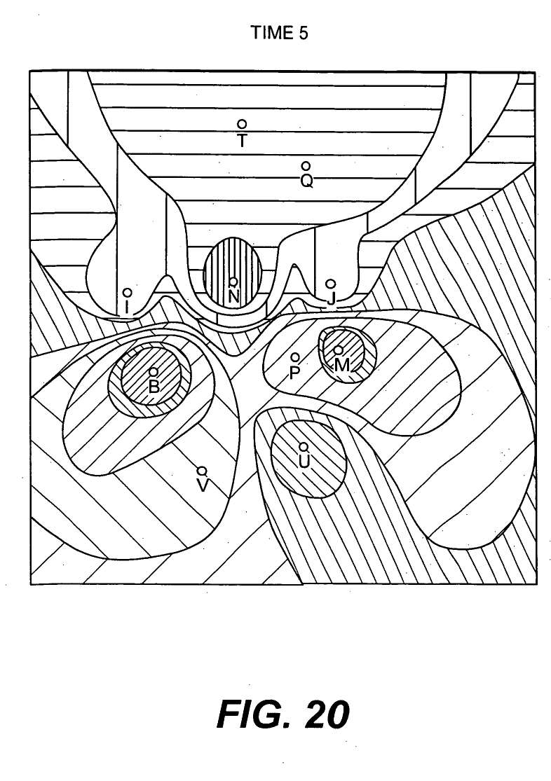

A Sociomap corresponding to a first time period (FIG. 16) depicts a generally low level of managerial potential. Only one of the core subjects with higher managerial potential is visible in the center. From the point of view of psychological profiles, subject D is the outsider (he is different from other members of the team). In the second Sociomap (FIG. 17), at time 2, a stronger cluster arises in the center comprising subjects J, E, R, and P). In the third Sociomap (FIG. 18), at time 3, newcomers differentiated the environment. During the next development (FIGS. 19 and 20), times 4 and 5, a strong cluster arises in the upper part of the Sociomap. It also surrounds other people in the team on the sides. In the end (FIG. 20) the average elevation rose, subjects B and M remained in a valley, but they seem to have similar profiles to other people (they are in the center).

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A system for visualizing information represented by data comprising:
a data collection unit;
a fuzzy logic coding unit;
a fuzzy logic model analysis unit; and
a sociomap generating unit that renders a visual representation of information represented by the collected data, the information resulting from the fuzzy logic coding model and the fuzzy logic model analysis unit.

2. The system of claim 1 further comprising:
a statistical interface unit for setting a statistical test graphically and visualizing a distribution of variables and statistical parameters in the sociomap.

3. The system of claim 1 wherein the fuzzy logic coding unit further comprises a matrix creator that transforms data into a matrix.

4. The system of claim 1 further comprising:
a module that generates a sociomap representative of at least one subject under observation.

5. A system for visualizing information represented by data comprising:
a fuzzy coding unit that generates at least one fuzzy model from the data;
a data aggregation unit that generates one aggregate model representative of the at least one fuzzy model generated by the fuzzy coding unit; and
a sociomap generating unit that renders a visual representation of the aggregate model.

6. The system of claim 5, wherein the fuzzy coding unit comprises:
means for generating a matrix from the data, wherein an element in said matrix indicates a degree of membership of a corresponding element of the data to a fuzzy set.

7. The system of claim 5, wherein the data aggregation unit comprises:
means for comparing fuzzy models to reveal a repeating pattern.

8. The system of claim 5, wherein the data aggregation unit comprises:
means for performing a statistical comparison of fuzzy models generated by said fuzzy coding unit.

9. The system of claim 5, wherein the data aggregation unit comprises:
means for creating an aggregate matrix that corresponds to the weighted average of individual matrices corresponding to fuzzy models generated by the fuzzy coding unit.

10. The system of claim 5, wherein the sociomap generating unit comprises:
a level line generator wherein the generated level line represents a fuzzy set.

11. The system of claim 5, wherein the sociomap generating unit comprises:
a level line generator wherein the generated level lines represent levels of subsystem interconnection.

12. The system of claim 5, wherein the sociomap generating unit comprises:
a level line generator wherein the generated level lines represent levels of cluster interconnection.

13. The system of claim 5, wherein the sociomap generating unit comprises:
a three-dimensional map generator wherein two-dimensions of the three-dimensional map represent a proximity of elements in the aggregated model.

14. A method for visualizing information represented by data comprising:
processing the data with a fuzzy logic coding unit;
generating a fuzzy logic model related to the processed data; and
generating a sociomap visual representation of information represented by the data.

15. The method of claim 14 further comprising:
setting a statistical test graphically and visualizing a distribution of variables and statistical parameters in the sociomap.

16. The method of claim 14 further comprising:
generating a sociomap representative of at least one subject under observation.

17. A method for visualizing information represented by data comprising:
generating at least one fuzzy model from the data;
generating one aggregate model representative of the at least one fuzzy model generated by the fuzzy coding unit; and
generating a sociomap that renders a visual representation of the aggregate model.

18. The method of claim 17, wherein generating at least one fuzzy model comprises:
generating a matrix from the data, wherein an element in said matrix indicates a degree of membership of a corresponding element of the data to a fuzzy set.

19. The method of claim 17, wherein generating one aggregate model comprises:
comparing fuzzy models to determine the existence of a repeating pattern.

20. The method of claim 17, wherein generating one aggregate model comprises:
performing a statistical comparison of fuzzy models generated.

21. The method of claim 17, wherein generating one aggregate model comprises:
creating an aggregate matrix that corresponds to the weighted average of individual matrices corresponding to fuzzy models.

22. The method of claim 17, wherein generating a sociomap comprises:
generating a level line representing a fuzzy set.

23. The method of claim 17, wherein generating a sociomap comprises:
generating a level line representing a level of subsystem interconnection.

24. The method of claim 17, wherein generating a sociomap comprises:
generating a level line representing a level of cluster interconnection.

25. The method of claim 17, wherein generating a sociomap comprises:
generating a three-dimensional map wherein two-dimensions of the three-dimensional map represent a proximity of elements in the aggregated model.
